(19) United States
(12) Patent Application Publication
(10) Pub. No.: US 2005/0041028 A1
(43) Pub. Date: Feb. 24, 2005

(54) Computer aided design (CAD) system

(75) Inventor: Richard Coutts, Cambridge, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: 123-D SOFTWARE, INC., Boston, MA (US)

(21) Appl. No.: 10/837,253

(22) Filed: Apr. 30, 2004

Related U.S. Application Data
(60) Provisional application No. 60/467,569, filed on May 2, 2003.

(51) Int. Cl. H01M 2/12

(52) U.S. Cl. 345/441

(57) ABSTRACT

The present invention provides a CAD system that is particularly suitable for running on a PDA. A CAD system of the invention includes a plurality of tools for generating drawings. In particular, one such tool allows generating a plurality of line segments and gap segments that are selectively positioned relative to the line segments.

### RELATED APPLICATIONS

This application claims priority to a provisional application entitled “Computer Aided Design (CAD) System,” filed on May 2, 2003, and having an Application Ser. No. 60/467,569. This provisional application is incorporated herein in its entirety.

### BACKGROUND OF THE INVENTION

The present invention relates generally to an enhanced CAD system for generating drawings, and more particularly, it relates to such a CAD system that provides enhanced functionality.

A variety of CAD systems are known in the art, and are utilized by a variety of professionals, such as, engineers and architects, for generating drawings. These conventional CAD systems, though useful in accomplishing many tasks, are in need of improvement for providing a user with more flexibility and efficiency in creating and/or modifying drawings.

Thus, there is a need for CAD systems that can be readily utilized.

Moreover, there is a need for such CAD systems that provide enhanced functionality for generating drawings.

### SUMMARY OF THE INVENTION

The present invention provides a CAD system having enhanced functionality that can be implemented on a variety of platforms, and is particularly suited for implementation on a personal digital assistant (PDA), such as a Palm™ or PocketPC™ platform, although it can also be readily implemented on a desktop computer.

In one aspect, a CAD system of the invention provides a tool, herein referred to as “Lines-and-Gaps” tool or module, for generating one or more line segments and one or more gap segments that are selectively positioned relative to the line segments. More particularly, a “Lines-and-Gaps” module according to the teachings of the invention allows a user to generate successive line and gap segments by selecting endpoints corresponding to these segments.

In a related aspect, the “Lines-and-Gaps” tool can generate a line segment upon selection of two points, by a user, corresponding to two endpoints of the line segment, and can generate a gap segment adjacent to the line segment upon selection of a third point along a direction defined by the line segment and separated from at least one of the two endpoints by a selected distance corresponding to the size of the gap. Another line segment can then be generated along the direction of the initial line segment, or in a direction forming a non-zero angle therewith, by simply choosing a fourth point at a selected distance from the third point. This process can be iteratively repeated to readily generate any drawing composed of a plurality of line and gap segments.

In another aspect, the invention provides a CAD system for creating drawings, which includes a tool for generating a first graphical object extending between first and second points, and generating a second different object that extends between the second point and a third point upon successive selection of these points, e.g., by a user, without any intervening operations, such as activating another tool. The first and second objects can have the same or different geometrical shapes. For example, in an architectural drawing, one object can represent a door and another object can represent a wall.

In yet another aspect, a CAD system according to the teachings of the invention includes an interface that provides a display area, and a tool for presenting alternating graphical objects of at least two different types in that display area upon successive selection of points that delimit those objects. A user can activate the tool by selecting an icon provided in the display area, which represents that tool. Further, the user can specify the position of each object relative to the two points that delimit that object's location, for example, by choosing pre-defined options in a menu or by providing the system with location data.

Further understanding of the invention can be obtained by reference to the following detailed description in conjunction with associated drawings described briefly below.

### BRIEF DESCRIPTION OF THE DRAWINGS

FIG. 1 illustrates a drawing formed of a plurality of line and gap segments that is generated by employing a “Lines-and-Gaps” tool in a CAD system according to the teachings of the invention,

FIGS. 2 and 3 schematically illustrate steps in generating the drawing shown in FIG. 1 by utilizing two tools available in a conventional CAD system,

FIG. 4 illustrates an interface utilized in a CAD system of the invention,

FIG. 5 illustrates exemplary drawings that can be generated by a module of a CAD system of the invention that extends the functionality of the “Lines-and-Gaps” module,

FIG. 6 illustrates a drawing consisting a series of alternating objects of two different types that can be generated by a tool of a CAD system of the invention,

FIG. 7 illustrates a drawing composed of alternating circles and squares, each of which is delimited by two successive points in a series of points selected by a user,

FIG. 8 illustrates an interface of a CAD application according to one embodiment of the invention implemented on a Palm™ platform,

FIG. 9 illustrates a pop-up keypad of the application of FIG. 8, and

FIG. 10 illustrates a drawing menu of the CAD application of FIG. 8.

### DETAILED DESCRIPTION

The present invention relates to a computer aided design system that is particularly suited for implementation on a personal digital assistant (PDA), such as a Palm™ or PocketPC™ platform. A CAD system of the invention can include a plurality of tools, also herein referred to as modules, each of which provides a selected functionality. These tools cooperatively provide a CAD system that can be readily utilized, especially in the field, to generate a variety of drawings, such as, architectural floor plans.

In one embodiment, a CAD system of the invention includes a plurality of drawing tools, herein also referred to as Draw tools, that allow a user to add lines, shapes and text to a drawing. These tools can include, without limitation, a “Line” tool for generating a line segment, a “Polyline” tool for generating a polygon, and 3-Pt Arc tool for generating an arc by specifying three points on the arc, a “Radius Arc” tool for generating an arc by specifying an endpoint of the arc, a radius, and an angle that the arc subtends. Other tools can include, for example, a “Box” tool for generating a box, a “Circle” tool for generating a circle, and an “Ellipse” tool for generating an ellipse. In addition, a CAD system of the invention can include a “Lines and Gaps” tool for generating line segments selectively separated by gaps, as described in more detail below. Moreover, a CAD system of the invention can include a “Text” tool that can be utilized to insert text into a drawing. Those having ordinary skill in the art will appreciate that the above list of tools is not intended to be exhaustive, and other tools can also be employed in a CAD system according to the teachings of the invention.

The “Lines-and-Gaps” tool in a CAD system of the invention allows generating a plurality of line segments interspersed with gap segments that selectively separate these line segments. In other words, this tool allows drawing a plurality of line segments with gaps separating selected ones of these line segments. More specifically, the “Lines-and-Gaps” tool can be utilized to generate successive line segments and gap segments along a given direction by successive selection of points in that direction. For example, two line segments separated by a gap segment can be generated by simply selecting, in succession, four points such that the first and second points correspond to the endpoints of one of the line segments, the second and the third points correspond to the beginning and the end of the gap segment, and the third point and the fourth point correspond to the two endpoints of the second line segment. Subsequent to the selection of the fourth point, if another point along a direction different from that defined by the first two line segments is selected, another line segment connecting the fourth point to the fifth point is generated. In this manner, a plurality of line and gap segments can be formed such that along any given direction, line segments separated by one or more gap segments can be generated by simply selecting points corresponding to the endpoints of these segments.

Hence, a “Lines-and-Gaps” module of a CAD system of the invention allows generating a plurality of lines selectively separated by one or more gap segments by utilizing a single tool and selecting successive points corresponding to the beginnings and the ends of the line and the gap segments without any other intervening operations, e.g., without activating another tool.

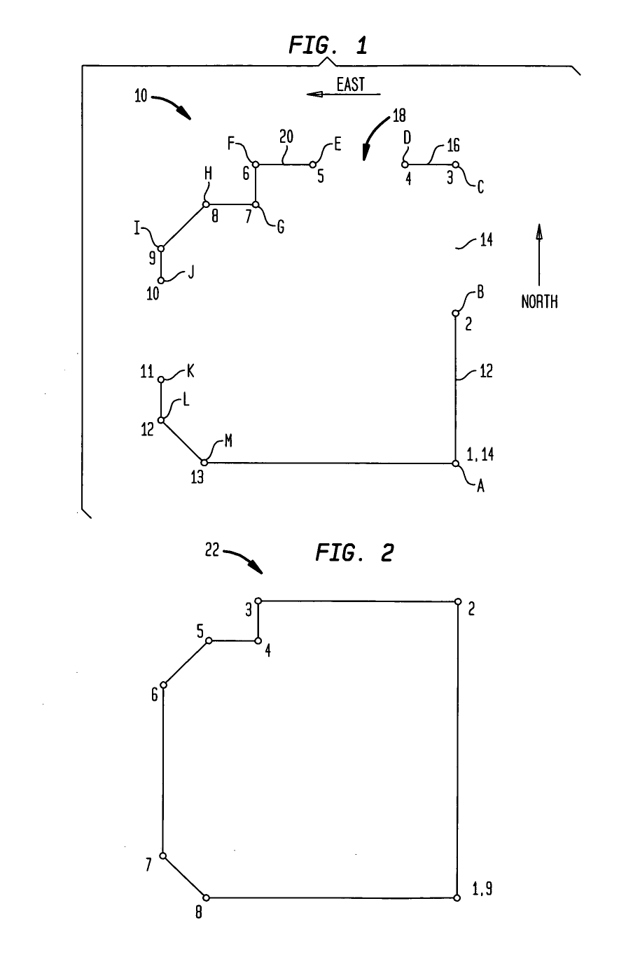

By way of example and for further illustration of the functionality of the “Lines-and-Gaps” module of a CAD system of the invention, FIG. 1 illustrates a drawing 10, e.g., an architectural floor plan, that is generated by employing the “Lines-and-Gaps” tool of the invention. To generate the drawing 10, an initial line segment 12 can be generated by selecting point A followed by point B corresponding to two endpoints of the line segment 12. Subsequent selection of a point C along the same direction as that of the line segment 12, herein referred to as direction NORTH, results in generating a gap segment 14 adjacent to the line segment 12. Another line segment 16 perpendicular to the direction NORTH, herein referred to as direction EAST, can then be generated by selecting a point D, followed by generating a gap segment 18 by selection of a point E, and another line segment 20 by selection of a point F. The above procedure can then be iteratively repeated to generate the drawing 10. It should be understood that the drawing 10 can also be generated by initially selecting a line segment other than the line segment 12 employed in the above exemplary procedure.

In some embodiments, a line segment is generated, e.g., by default, between the first two initial selected points followed by alternating gap and line segments as additional points are successively selected. Alternatively, a gap segment can form the initial segment that is generated. Further, in some embodiments, a user can specify, for example, by selecting an option presented in a menu, whether a line or a gap forms the initial segment.

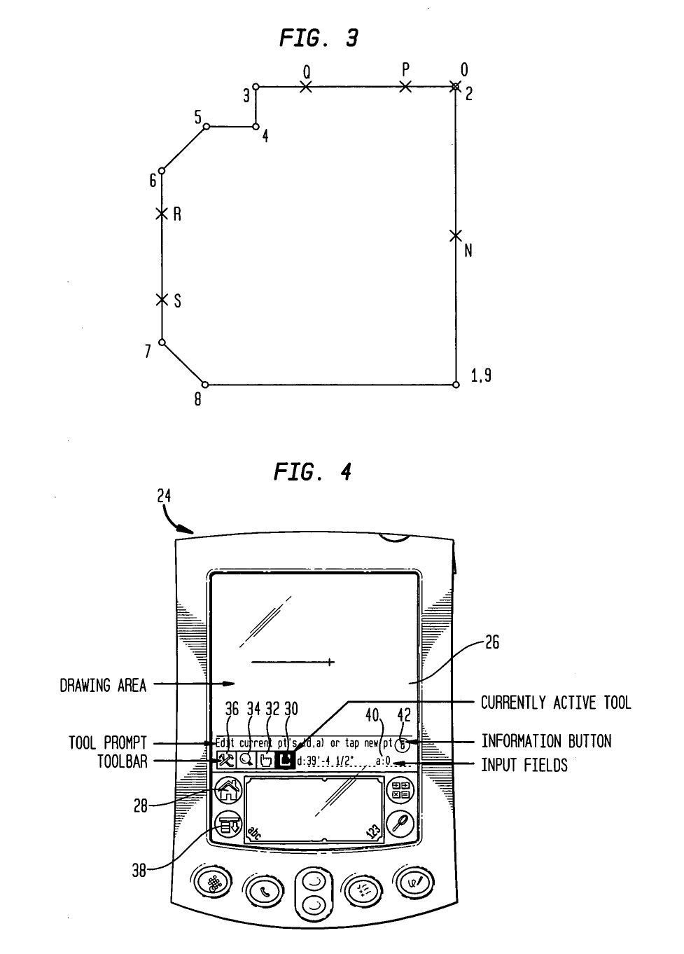

A “Lines-and-Gaps” module in a CAD system of the invention substantially facilitates generating drawings having a plurality of line segments selectively separated by a plurality of gap segments. In particular, it allows generating such drawings by utilizing a single tool rather than employing two or more tools in a conventional CAD system. To further appreciate the enhanced functionality provided by the “Lines-and-Gaps” tool of the invention, FIGS. 2 and 3 schematically illustrate exemplary steps for generating the above floor plan 10 by employing tools available in conventional CAD systems. As shown in FIG. 2, initially a polygon 22 formed of consecutive line segments connected head to tail can be generated, based on user-specified endpoints, by employing, for example, a Polyline tool. Subsequently, selected points, such as points N, O, P, Q, R, and S, can be cut in order to remove segments corresponding to the gap segments present in the drawings 10. Hence, generating the drawing 10 by utilizing conventional tools is at best a two-step process requiring two separate tools. In contrast, the “Lines-and-Gap” module of a CAD system of the invention allows generating the same drawing by employing a single tool.

Although a CAD system according to the teachings of the invention can be implemented on a variety of platforms, in one preferred embodiment, the platform is selected to be a personal digital assistant (PDA), such as a Palm™ or PocketPC™. Such platforms are especially suited for generating drawings, e.g., architectural floor plans, in the field. This allows a user, for example, an architect to generate drawings, such as, floor plans, in the field, and subsequently, download the floor plans, if desired, onto other platforms, such as, a personal computer (PC) in the architect's office. This advantageously allows the architect to generate drawings while at a site away from office, e.g., at a construction site, without a need for carrying even laptop computers to the site.

It should, however, be understood that various modules of a CAD system of the invention, including the “Lines-and-Gaps” module can be implemented on platforms other than a PDA, such as, desktop computers.

A CAD system of the invention can provide a variety of different interfaces that allow a user to access to different tools available for generating, editing, and viewing drawings. By way of example, FIG. 4 illustrates an interface 24 in an exemplary implementation of a CAD system of the invention on a Palm™ or PocketPC™ platform that includes a drawing/display area 26 below which a plurality of graphical objects, in the form of buttons, are provided. These graphical objects allow a user to access various functionalities of the CAD system. For example, each button in a toolbar 28 can be activated to access selected tools. More specifically, pressing a toolbar button can result in appearance of a pop-up menu containing several tools, each of which can be individually activated. For example, a toolbar button 30 can be activated to access Draw tools described above. Other toolbar buttons 32, 34, and 36 can be activated to access, respectively, Select tools, View tools, and Build tools.

With continued reference to FIG. 4, additional features are accessible by tapping a menu button 38, which can activate a pull-down menu containing Drawings, Edit, and Settings menu items. In addition, the exemplary interface 24 includes input fields 40 that allow a user to enter selected attributes of graphical objects, e.g., line segments or arcs, generated in the drawing area 24. For example, activating the input fields can result in appearance of a pop-up keypad that allows a user to enter dimensions and angles associated with a graphical object in the drawing area. Moreover, the interface 24 includes an information button 42 that provides a user access to information regarding various aspects and functionalities of the CAD system.

One advantage of the above exemplary interface 24 is that the dimension of the drawing area relative to the portion devoted to various buttons for accessing tools, and other functionalities, is selected to provide a user with ample space for generating drawings while ensuring that various buttons can be readily accessed.

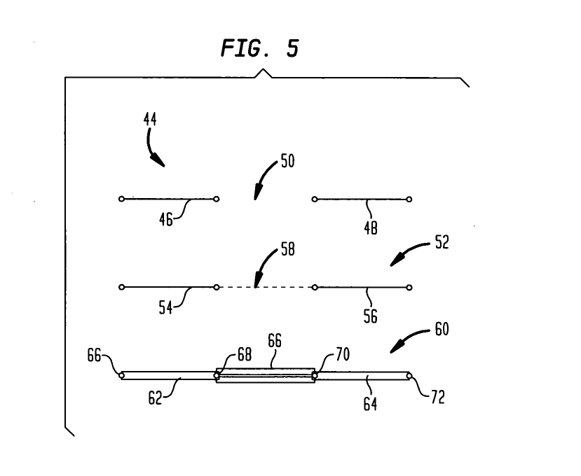

In some embodiments, a CAD system of the invention can include a module that is an extension of the above “Lines-and-Gaps” module in that, in addition to having the functionality of the above-described “Lines-and-Gaps” module, it allows generating drawing in which the above gap segments, and/or the line segments, can be substituted with any desired graphical object, such as, a line of a drawing style or color different that the line segments, or a group of several lines representing an object in the drawing, such as, a door or a window. For example, with reference to FIG. 5, this module can be utilized to generate a drawing 44 having two line segments 46 and 48 separated by a gap segment 50 by sequential selection of points corresponding to the beginning and the end of each segment without any other intervening operation, e.g., choosing another tool. In addition, and by way of example, this module can be utilized to generate another drawing 52 having two solid line segments 54 and 56 selectively separated by a dashed line 58 by selecting, in succession, points that define the limits of successive solid and dashed line segments. In another drawing, the dashed line segments, or the solid line segments, can be replaced with boxes or any other graphical objects of interest. For example, this module can be employed to generate a drawing 60 having graphical objects 62 and 64 separated by another graphical object 66 by successive selection of points 66, 68, 70, and 72. The drawing 60, for example, can represent an architectural floor plan in which the graphical objects 62 and 64 represent two wall segments, and the graphical object 66 represents a window or a door. It should be understood that the drawings 50, 52, and 62 are presented for illustrative purposes, and this module of a CAD system of the invention can be utilized to generate drawings having any desired number of one set of graphical objects separated selectively by another set of graphical objects through successive selection of points corresponding to limits of these objects.

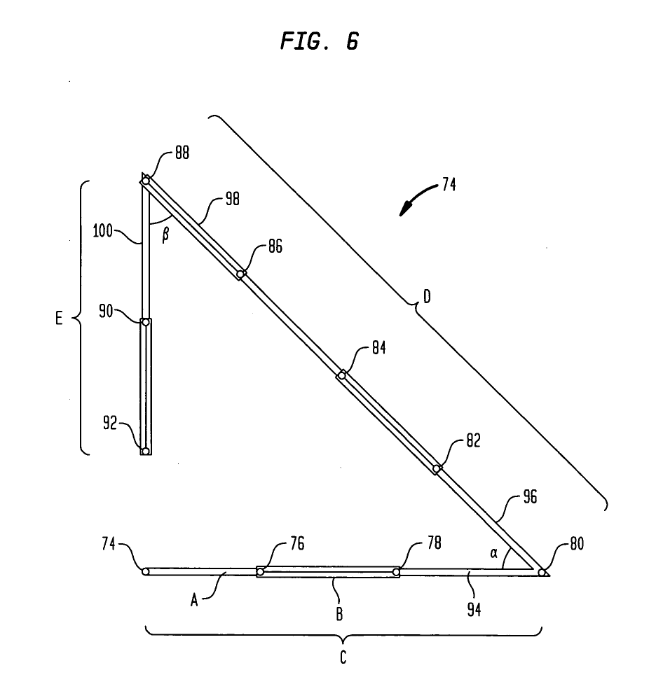

Further, any two neighboring graphical objects in a set of objects generated by a “Lines-and-Gaps” module of the invention can form any desired angle, e.g., zero or non-zero angles, relative to one another. By way of example, FIG. 6 schematically shows a drawing 74 formed as alternating succession of two types of graphical objects (objects A and B) by successive selections of points 74-92, each of which designates an endpoint of two neighboring objects. The neighboring objects form either vanishing or non-vanishing angles relative to one another. For example, any two neighboring objects in each of the segments C, D, or E form a zero angle relative to one another. On the other hand, objects 94 and 98 form non-zero angles α and β, respectively, with objects 96 and 100.

In many embodiments of the invention, when the “Lines-and Gaps” module, or an extension thereof, is utilized for generating a succession of different object types, a user can specify which object type would form the initial object generated between the first two selected points. Alternatively, the CAD system can provide this choice by default.

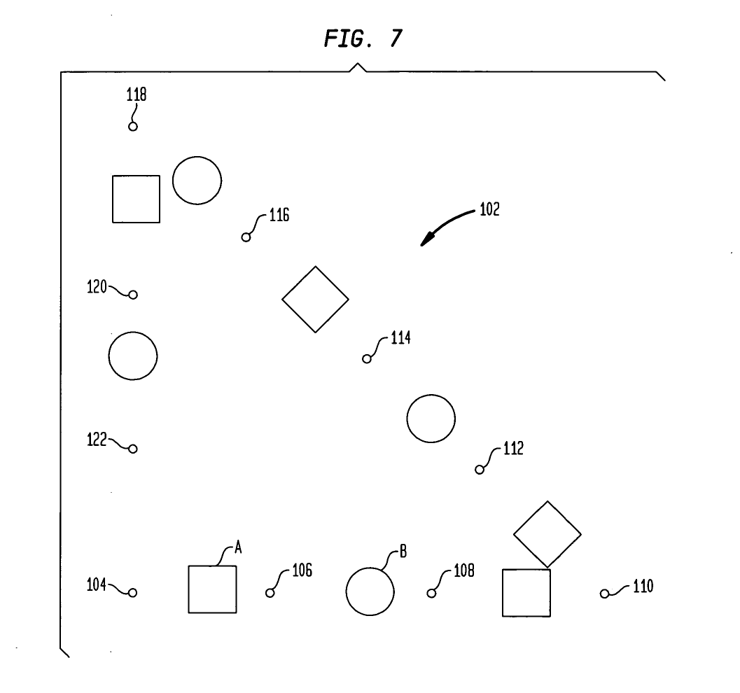

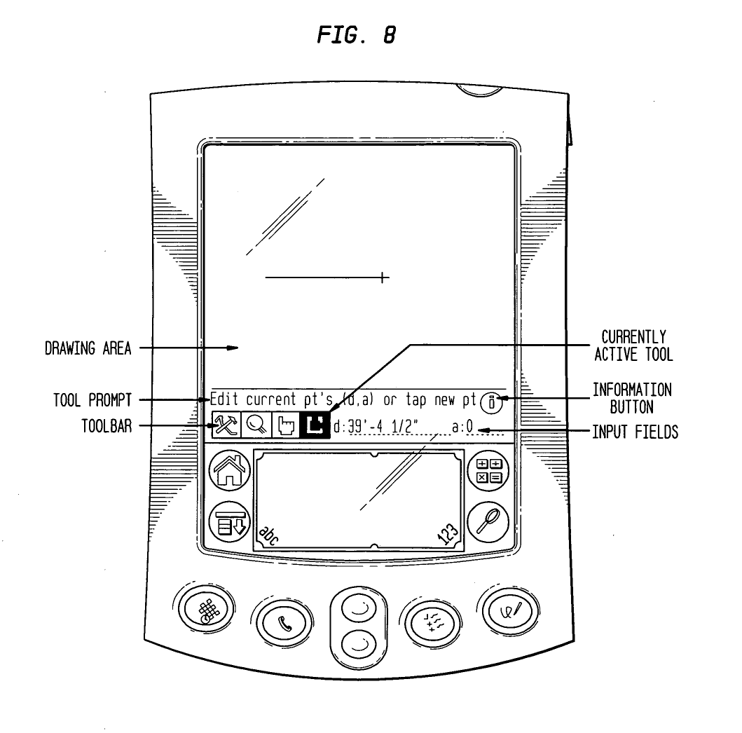

In the above exemplary embodiments of a “Lines-and-Gaps” module of the invention, selection of two successive points results in generation of an object that extends between those points. In another embodiment of the module, selection of two successive points results in generation of an object that is contained between those two points, but does not necessarily connect one point to the other. In other words, the successive points delimit the position of the object rather identifying its actual endpoints. As an example of the type of drawings that can be generated by utilizing this embodiment, FIG. 7 schematically shows a drawing 102 that includes alternating square and circle graphical objects, generated by successive selection of points 104-122 without any intervening operations. Each of the circles or the squares is contained between two points without being connected to either one. For example, points 104 and 106 delimit square A, and points 106 and 108 delimit circle B.

In this embodiment, the position of each object, e.g., each square or circle in FIG. 7, relative to the points delimiting its location can be selected by a user. For example, in some embodiments, the user is provided with a menu that presents a number of options for position of each object relative to the points within which it is contained, e.g., half-way between the points. Alternatively, a user can specify any desired location for the object, for example, as a percentage of distance between the two delimiting points relative to one of them. Although in some embodiments, the locations of two neighboring objects relative to their respective delimiters are the same, in some other embodiments, a user can specify different locations for two neighboring objects relative to their respective delimiters. For example, in the above FIG. 7, each circle and each square is positioned halfway between its respective delimiting points. In an alternative drawing, each circle and/or square can be generated closer to one delimiting point or the other, for example, based on a user's instructions.

A CAD system according to the teachings of the invention, and particularly its “Lines-and-Gaps” module, can find a variety of applications. For example, as noted above, an architect can utilize the CAD system of the invention, implemented on a PDA, in the field to generate architectural drawings. In another application, an interior designer can employ the system to map out the locations of various items, such as furniture, in a space. For example, the designer can employ the functionality described in connection with the above FIG. 7, to specify locations of various items of furniture in a room. In yet another application, a telecommunications technician can employ the system in the field to generate a map of power lines.

A CAD system according to the teachings can be implemented on various platforms by employing any suitable programming language. For example, various object oriented programming languages, such as, C++, Visual Basic, and Java™, can be utilized to implement a CAD system according to the invention. Those having ordinary skill in the art will, however, realize that various functionalities of a CAD system of the invention, and particularly, the “Lines-and-Gaps” module, can also be implemented by utilizing other object-oriented languages. Various modules of a CAD system of the invention can be implemented by employing routine programming practices known to those having ordinary skill in the art. Further, a CAD system of the invention can be implemented not only on a PDA but any other platform, e.g., desktop computers or work stations.

An exemplary implementation of a CAD system according to the teachings of the invention, marketed by Applicant under trade designation ZIPCAD is discussed below. It should be understood that the following description is provided for illustrative purposes, and is not intended to limit implementations of a CAD system of the invention.

With reference to FIG. 8, in this exemplary implementation, the most frequently used tools are accessible from a toolbar on the lower left corner of the screen. Pressing a toolbar button activates a popup menu containing several tools. Each toolbar button corresponds to one of four categories of tools. The categories and their tools are:

Draw Tools: Line, Polyline, 3-Point Arc, Radius Arc, Lines & Gaps, Box, Circle, Ellipse, Text.

Select Tools: Pick, Select All, Deselect All, Area Select, Area Inclusive.

View Tools: View All, Window, Previous View, Last View, Recenter, Zoom In/Out, Saved Views

Build Tools: Line Offset, Corner Trim, Line Trim, 2-Point Trim, Break Line, Delete Segment, Mirror, Stretch, Rotate, Move, Resize, Group/Ungroup, Query, Measure, Calculate Area

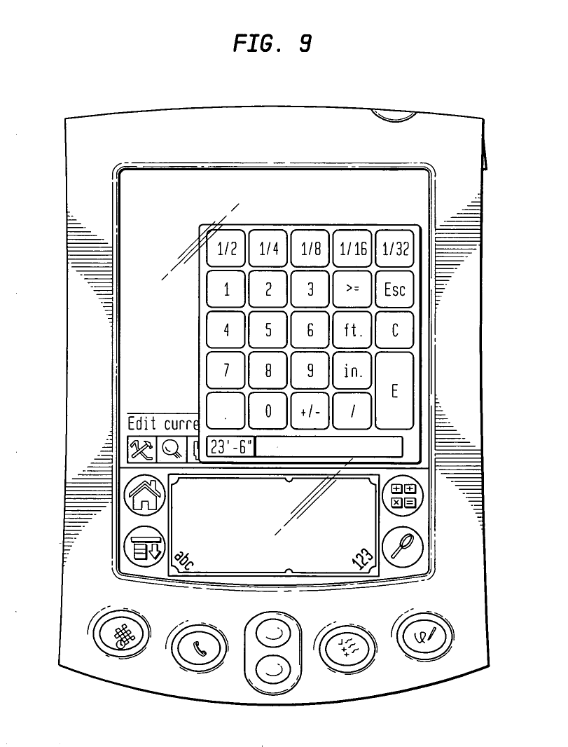

A more detailed description of each tool is provided below. Most tools prompt the user through a series of steps. As the user taps locations or other information, the data is displayed in the lower right portion of the screen. Tapping an input field will cause a keypad to pop-up, which allows a user to modify parameter values (as shown in FIG. 9).

Keypads allow users to enter precise dimensions and angles. The coordinate system can be set based on a user preference as either a Cartesian (x, y) or a Polar (distance, angle) coordinate. Likewise, lengths can be entered in metric or English units, and English measurements can be entered as feet,-inches or as decimal.

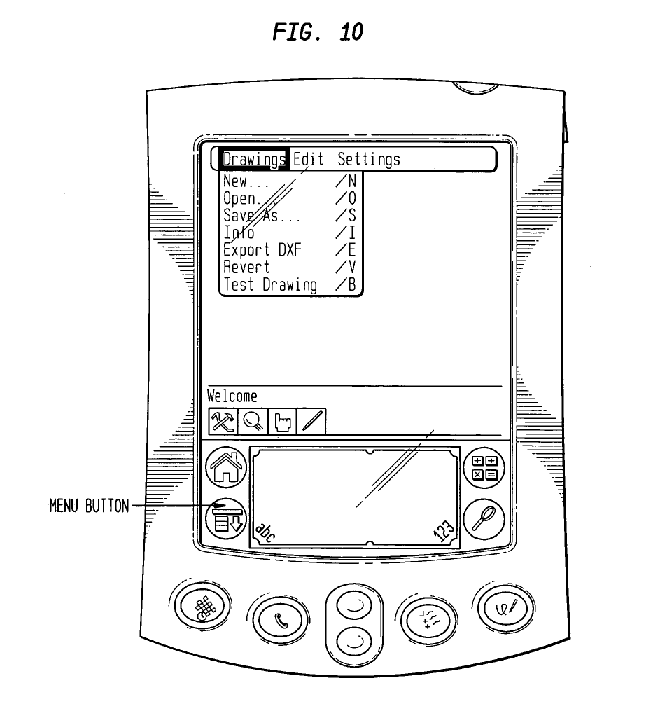

As shown in FIG. 10, additional features are accessible by tapping the Palm menu button to the left of the Graffiti writing area. Three pull down menus are provided: Drawings, Edit, and Settings. The Drawings menu is similar to the File menu common to most desktop software applications; where drawings can be created, opened, exported, etc. The Edit menu also has common editing features such as cut/copy/paste, undo/redo, delete, etc. Finally, the Settings menu is specific to CAD features. Here is where drawing attributes, such as the current line type, color, layer settings, etc, are set.

In this implementation, the main toolbar on the lower left portion of the screen has four buttons. To activate a tool, an appropriate button of the tool bar can be tapped and a tool item from a pop-up menu can be selected.

Some tools are modal and their icons are displayed in the toolbar while the tool is active (see, e.g., FIG. 8). Other tools, such as the View All tool, simply perform their respective operations and then return control back to the previously active tool.

Using a tool generally requires specifying locations in the drawing by tapping. Below are exemplary tools available from the toolbar.

Draw Tools

The right-most button of the toolbar displays the Draw tools. These tools add lines, shapes and text to the drawings:

Line, Polyline, 3-Pt Arc, Radius Arc, Box, Circle, Ellipse: These tools are consistent with most CAD applications.

Lines & Gaps: This is one embodiment of a tool according to the teachings of the invention described above. It can be utilized to leave gaps between line segments when the preceding line was drawn in the same direction This tool is particularly helpful for rectilinear drawings with openings, such as floor plans.

Text: To enter text, the location for the text can be tapped and then the text can be entered using the Graffiti area. The size of the text can be specified by utilizing “Settings>Preferences>Text Size.” Text in the drawing can be edited by selecting it with the Pick tool described in “Select Tools” below.

Select Tools

In this implementation, many tools operate only on selected objects. For example, “Edit>Delete” will delete selected entities and groups in a drawing. Selected objects are indicated as being drawn more thickly than unselected objects. Below are the Select tools available from the toolbar:

Pick: Entities and groups can be tapped to select them. Tapping selected objects deselects them.

Select All/Deselect All: Selects/deselects all of the visible objects in a drawing, including objects outside of the screen's viewing area. Objects on layers that are not visible are not affected.

Area Select: Selects objects completely contained in a user-specified rectangular window.

Area Include: Select objects completely and/or partially contained in a user-specified rectangular window.

View Tools

There are several ways to navigate the drawing. Below are the View tools available from second button from the left:

View All: This will bring visible on- and off-screen objects to within view.

Window: Allows the user to specify a rectangular viewing window.

Previous View: Returns to the previous view in which the drawing was modified.

Last View: Returns to the most recent view in which the drawing was modified.

Recenter: Allows the user to tap a new center for the viewing area.

Zoom In: Enlarges the current view of a drawing.

Zoom Out: Shrinks the current view of a drawing.

Saved Views: Shows a dialog for saving and managing views. Views remember the viewing area of the drawing and the layer settings. For large drawings, saving views for fast recall can be a timesaver.

Build Tools

The following tools for trimming entities, moving, mirroring, etc., are collectively referred to as Build tools:

Corner Trim: Trims two user selected lines to form a corner. The lines are selected after the tool is activated.

Offset: Copies an entity to a specified offset distance. If the “Fix d” button is activated, the distance is fixed by the value in the “d:” input field. When not activated the distance is specified by the tap of the stylus. The user can toggle the “Fix d:” activation on or off at anytime by tapping its button.

Line Trim: Trims entities to the specified line.

2-Pt Trim: Performs the same operation as Line Trim except the user specifies a trim line by selecting two points.

Break Line: Breaks an entity at the tapped point. If two or more lines are tapped at the same time (e.g., a line intersection) then the selected line is given precedence.

Del Segment: Deletes a segment from an entity. When selecting circles or ellipses, a point on a portion of the curve to be deleted is tapped.

Mirror: Reflects selected entities about a line specified by two points.

Stretch: “Stretches” objects by moving some of their points a specified distance. This is not a proportional stretch, but rather moves all of the points within the user-specified window by the given distance.

Move/Rotate: Moves/rotates the selected objects a given distance/angle. Executing the “Edit>Duplicate” tool immediately after these tools will create a copy of the objects with offset specified.

Resize: Enlarges or shrinks selected objects a specified amount.

Group/Ungroup: Group collects entities into a single group that can be selected with a single tap. Ungroup disassembles a group into its original objects.

Query: Gives information about the selected objects. If more than one object is selected when the tool is activated, it gives all of the information common to the selected objects. After activation, it gives information on subsequently tapped objects.

Measure: Displays the distance between two user-specified points. The default display is Cartesian (x,y). This format will display the distance along the x- and y-axis. To change the display to Polar, which will give the total distance between the points and the corresponding angle, the setting of “Setting>Preferences>Coordinates” can be changed to Polar while this tool is active.

Area: Calculates the area of a user-specified polygon. If any lines of the polygon overlap, the area is invalid and a 0.0 is displayed.

Snapping

Most of the aforementioned tools require a user to specify locations on the screen by tapping. When snapping is enabled, the user's tap may be interpreted as certain snap locations, such as line intersections, end-points, etc. “Settings>Snap Preferences.” can be utilized to specify tapping behavior.

Anytime Viewing

Two View tools for navigating the drawing are always active:

Anytime Recenter-and-Zoom: To change the center of a viewing area at anytime, a stylus can be held to the screen. After a short delay, the location indicated by the stylus will move to the center of the screen. If the stylus is continued to be held to the screen, the system will zoom in on that location. This operation can be performed at anytime, even when using another tool that expects a tap (the delayed tap for Recenter and-Zoom will be ignored by the currently active tool)

HardKey Pan-and-Zoom: A drawing can be panned and zoomed at anytime using the hard keys at the bottom of the device (Calendar, Addresses, etc.) For most Palm OS handhelds that have an up/down key in the center, the key mapping is:

Calender: Zoom Out

Addresses: Pan Left

Up: Pan Up

Down: Pan Down

Tasks: Pan Right

Memo Pad: Zoom In

For devices that have a four-way navigator button with a select button, the key mapping is

Calender: View All

Addresses: Zoom Out

4-way navigation: Pan left/right/up/down

Select: Zoom In.

Tasks: Previous View

Memo Pad: Last View

Menu Tools

Several tools are available from the pull down menus, accessible by tapping the handheld's menu button (FIG. 10). Below is a list of the menus and their tools.

Drawings Menu

The Drawings Menu is very similar to the File menu found in most desktop software applications.

New: Start a new drawing. If the drawing currently being edited is named, it is automatically saved. If it is not named, the user is given the option of saving the drawing with a name or discarding the drawing.

Open . . . , Save As . . . : Similar to New, these features save or give the option of discarding the currently active drawing. They then display a File Dialog box listing all of the ZIPCAD drawings on the handheld. These dialogs also give the user the option of deleting existing drawings.

Revert: Discards all of the changes made since the drawing was last saved.

Info: Displays information about a drawing, such as the size of the drawing and the number of entities.

Export DXF: Queues the drawing for DXF file exporting during the next HotSync operation. In this implementation, the status of the drawing at the time of the HotSync operation is what is exported, not the state of the drawing when the export was queued. Exporting will be canceled if the drawing is deleted.

Edit Menu

This menu is similar to the Edit menu on most desktop software applications. The features available from this menu are:

InfiniteUndo/Redo: Any change to the drawing can be undone or redone with these tools. Exiting the drawing clears the Undo/Redo stack.

Cut/Copy/Paste: These are ZiPCAD clipboard features for moving or copying objects across layers and drawings.

Delete: Similar to Cut, except a copy of the objects is not placed on the clipboard.

Settings Menu

This menu allows users to customize their drawings and ZiPCAD preferences to their liking.

Layers: Layers can be added, deleted, renamed, toggled on/off, and set as the active layer. The active layer receives all newly created entities.

Line Types/Colors: Four line types are available: solid, dotted, dashed, and dot-dashed. Selecting a line type will change the type for all of the selected entities and for all newly created entities. For handhelds that support color, 16 user-customized colors are provided. When DXF files are exported, no color table is exported. Rather, only the color index (1-16) for each object is exported. This allows customizing ZiPCAD color table to match the settings of desktop CAD program.

Snap Preferences: The snap settings available in this implementation are End-Point, Mid-Point, Perpendicular, Intersection, Curve Quadrant, and Snap Angle. These can be used in any combination. The maximum distance between the tap location and the snap point is specified by the Snap Aperture setting.

Help: This provides a much-abbreviated version of a manual for the application. When running certain ZiPCAD tools a small information button with an “i” in it appears in the lower right-hand corner of the screen (see FIG. 8). This button can be tapped to obtain information regarding the currently active tools.

About ZiPCAD: Displays some company information and the “Register . . .” button allowing unregistered users to enter the unique ZiPCAD key.

Those having ordinary skill in the art will appreciate that various modifications can be made to the above embodiments without departing from the scope of the invention.

1. In a CAD system having a display and a plurality of tools for generating drawings, the improvement comprising:
a module for generating in said display a plurality of line segments and a plurality of gap segments separating selected ones of said line segments by successive selection of points corresponding to the endpoints of said line and gap segments without any intervening operation.

2. The CAD system of claim 1, wherein said module generates a line segment upon selection of two points corresponding to two endpoints of said line segment, and generates a gap segment adjacent to said line segment upon selection of third point in a direction along said line segment and separated from at least one of said endpoints.

3. The CAD system of claim 1, wherein said module generates a line segment and a gap segment sharing an endpoint with the line segment upon consecutive selection of first, second and third points corresponding to endpoints of said line and said gap segments.

4. The CAD system of claim 3, wherein the line segment and the gap segment form a non-zero angle relative to one another.

5. The CAD system of claim 3, wherein said line segment and said gap segment share said second point.

6. The CAD system of claim 3, wherein said module generates another line segment between said third point and a fourth point upon selection of said fourth point.

7. The CAD system of claim 1, wherein said CAD system is implemented on a personal digital assistance (PDA) platform.

8. The CAD system of claim 7, wherein said PDA platform comprises any of a Palm™ or a PocketPC™ platform.

9. The CAD system of claim 1, further comprising an interface providing said display for presenting said line and gap segments.

10. The CAD system of claim 1, further comprising a graphical object presented in said interface corresponding to said module, wherein selection of said graphical object activates said module.

11. In a CAD system for generating drawings, the improvement comprising:
a tool for generating a first graphical object extending between first and second points, and a second different graphical object extending between said second point and a third point upon successive selection of said first, second and third points without any intervening operations.

12. The CAD system of claim 11, wherein said first and second graphical objects comprise different geometrical objects.

13. The CAD system of claim 11, wherein said first graphical object comprises a solid line segment and said second graphical object comprises a dashed line segment.

14. In a CAD system for generating drawings, the improvement comprising:
an interface providing a display area, and
a tool for presenting alternating graphical objects of two different types in said display upon successive selection of points in said display delimiting said graphical objects.

15. The CAD system of claim 14, further comprising an icon corresponding to said tool, said icon being displayed in said interface, wherein selection of said icon activates said tool.

16. The CAD system of claim 14, wherein said tool positions each graphical object at a selected location relative to its delimiting points based on instructions from a user.
